(19) United States
(12) Patent Application Publication
(10) Pub. No.: US 2014/0266526 A1
(43) Pub. Date: Sep. 18, 2014

(54) METHOD FOR MAKING AND USING MAGNETIC STRUCTURES IN SEMI-FLEXIBLE MATERIAL

(71) Applicant: Correlated Magnetics Research, LLC, Huntsville, AL (US)

(72) Inventors: Wesley R. Swift, JR., Huntsville, AL (US); Larry W. Fullerton, New Hope, AL (US)

(73) Assignee: Correlated Magnetics Research, LLC, Huntsville, AL (US)

(21) Appl. No.: 14/198,416

(22) Filed: Mar. 5, 2014

Related U.S. Application Data
(60) Provisional application No. 61/800,799, filed on Mar. 15, 2013.

(51) Int. Cl. H01F 7/02

(52) U.S. Cl. CPC H01F 7/0215
USPC 335/306

(57) ABSTRACT

A semi-flexible magnetic structure includes a flexible layer and a plurality of magnetizable elements adhered to the flexible layer such that there is a spacing between magnetizable elements of the plurality of magnetizable elements, where each magnetizable element of said plurality of magnetizable elements is a solid piece of magnetizable material. The spacing between magnetizable elements enables the semi-flexible magnetic structure to bend around an object. The semi-flexible magnetic structure can be being magnetized to have a plurality of magnetic sources in a polarity pattern.

### RELATED APPLICATIONS

This Non-provisional patent application claims the benefit of U.S. Provisional Patent Application No. 61/800,799, filed Mar. 15, 2013, titled “Method for Making and Using Magnetic Structures in Semi-Flexible Material”, which is incorporated herein by reference.

### FIELD OF THE INVENTION

The present invention relates to coded magnetic systems structures and methods and more particularly to the arrangement of such structures.

### SUMMARY OF THE INVENTION

A semi-flexible magnetic structure including a flexible layer and a plurality of magnetizable elements adhered to the flexible layer such that there is a spacing between magnetizable elements of the plurality of magnetizable elements that enables the semi-flexible magnetic structure to bend around an object, the semi-flexible magnetic structure being magnetized to have a plurality of magnetic sources in a polarity pattern, where each magnetizable element of the plurality of magnetizable elements is a solid piece of magnetizable material.

Each magnetic source of the plurality of magnetic sources can be magnetized by positioning an aperture of an inductor coil of a magnetizer at a location adjacent to a surface of said semi-flexible magnetic structure and exposing the location to a magnetizing field produced in and near said aperture.

Each magnetic source of the plurality of magnetic sources can have one of a first polarity or a second polarity exposed at the surface of the semi-flexible magnetic structure and an opposite polarity of the first polarity or the second polarity not exposed at the surface of the semi-flexible magnetic structure.

The flexible layer may be rubber, plastic, or fabric.

The flexible layer can be flexibly deformable.

The flexible layer can be elastically deformable.

At least one of the magnetizable elements of the plurality of magnetizable elements can be one of round, square shaped, hexagonal shaped, or triangle shaped.

The plurality of magnetizable elements can be configured as a grid.

The grid may be made up of rows and columns.

The spacing between magnetizable elements can be a uniform spacing or a non-uniform spacing.

The magnetizable elements of the plurality of magnetizable elements can have the same shape but different sizes.

The magnetizable elements of the plurality of magnetizable elements can have the same size but different shapes.

Different portions of the semi-flexible magnetic structure can be designed such that one portion has a different bend modulus from another portion.

The semi-flexible magnetic structure can be magnetized to have substantially uniform magnetic properties.

Different portions of the semi-flexible magnetic structure can be magnetized to have different magnetic properties, wherein said magnetic properties comprises one of magnetic field strength properties, tensile force properties, or shear force properties.

The semi-flexible magnetic structure can be magnetized in accordance with a coded polarity pattern enabling the semi-flexible magnetic structure to correlate with a second semi-flexible magnetic structure also magnetized in accordance with the coded polarity pattern.

### BRIEF SUMMARY OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 depicts an exemplary semi-flexible magnetic structure having square shaped magnetizable elements.

FIG. 2A depicts a side view of an exemplary semi-flexible magnetic structure with magnetizable elements of a certain size arranged with a certain spacing.

FIG. 2B depicts a side view of another semi-flexible magnetic structure in which the size of magnetizable elements has been decreased from the size of the magnetizeable elements of FIG. 2A.

FIG. 2C depicts a side view of yet another semi-flexible magnetic structure in which the spacing between of magnetizable elements has been increased from the spacing between the magnetizable elements of FIG. 2A.

FIG. 3 depicts an exemplary semi-flexible magnetic structure having round shaped magnetizable elements.

FIG. 4 depicts an exemplary semi-flexible magnetic structure having triangle shaped magnetizable elements.

FIG. 5 depicts an exemplary semi-flexible magnetic structure having hexagonal shaped magnetizable elements.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

Certain described embodiments may relate, by way of example but not limitation, to systems and/or apparatuses comprising magnetic structures, magnetic and non-magnetic materials, methods for using magnetic structures, magnetic structures produced via magnetic printing, magnetic structures comprising arrays of discrete magnetic elements, combinations thereof, and so forth. Example realizations for such embodiments may be facilitated, at least in part, by the use of an emerging, revolutionary technology that may be termed correlated magnetics. This revolutionary technology referred to herein as correlated magnetics was first fully described and enabled in the co-assigned U.S. Pat. No. 7,800,471 issued on Sep. 21, 2010, and entitled “A Field Emission System and Method”. The contents of this document are hereby incorporated herein by reference. A second generation of a correlated magnetic technology is described and enabled in the co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. Pat. No. 8,179,219, issued May 15, 2012, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581 issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568 issued Jul. 19, 2011 which is all incorporated herein by reference in its entirety. Material presented herein may relate to and/or be implemented in conjunction with energy generation systems and methods such as described in U.S. patent application Ser. No. 13/184,543 filed Jul. 17, 2011, which is all incorporated herein by reference in its entirety. Such systems and methods described in U.S. Pat. No. 7,681,256 issued Mar. 23, 2010, U.S. Pat. No. 7,750,781 issued Jul. 6, 2010, U.S. Pat. No. 7,755,462 issued Jul. 13, 2010, U.S. Pat. No. 7,812,698 issued Oct. 12, 2010, U.S. Pat. Nos. 7,817,002, 7,817,003, 7,817,004, 7,817,005, and 7,817,006 issued Oct. 19, 2010, U.S. Pat. No. 7,821,367 issued Oct. 26, 2010, U.S. Pat. Nos. 7,823,300 and 7,824,083 issued Nov. 2, 2011, U.S. Pat. No. 7,834,729 issued Nov. 16, 2011, U.S. Pat. No. 7,839,247 issued Nov. 23, 2010, U.S. Pat. Nos. 7,843,295, 7,843,296, and 7,843,297 issued Nov. 30, 2010, U.S. Pat. No. 7,893,803 issued Feb. 22, 2011, U.S. Pat. Nos. 7,956,711 and 7,956,712 issued Jun. 7, 2011, U.S. Pat. Nos. 7,958,575, 7,961,068 and 7,961,069 issued Jun. 14, 2011, U.S. Pat. No. 7,963,818 issued Jun. 21, 2011, and U.S. Pat. Nos. 8,015,752 and 8,016,330 issued Sep. 13, 2011, and U.S. Pat. No. 8,035,260 issued Oct. 11, 2011 are all incorporated by reference herein in their entirety.

Material presented herein may relate to and/or be implemented in conjunction with systems and methods described in U.S. Provisional Patent Application 61/640,979, filed May 1, 2012, titled “System for Detaching a Magnetic Structure from a Ferromagnetic Material”, which is incorporated herein by reference. Material may also relate to systems and methods described in U.S. Provisional Patent Application 61/796,253, filed Nov. 5, 2012, titled “System for Controlling Magnetic Flux of a Multi-pole Magnetic Structure”, which is incorporated herein by reference. Material may also relate to systems and methods described in U.S. Provisional Patent Application 61/735,403, filed Dec. 10, 2012, titled “System for Concentrating Magnetic Flux of a Multi-pole Magnetic Structure”, which is incorporated herein by reference.

In some applications, it is desired that magnetic structures be constructed in such a way that they are capable of being flexibly deformed. For example, any situation involving a need for a magnetic structure to be wrapped around or within another object is often better served by a flexible or semi-flexible magnetic structure than by an entirely rigid magnetic structure. There exist flexible materials that are entirely magnetizable, however there are limits to the magnetic field strength that can be imparted to magnetic structures constructed of these materials. There also exist flexible materials in which solid magnetizable particles are embedded. However, these materials also suffer many of the same drawbacks, as the low ratio of magnetizable to nonmagnetizable material imposes a limit on the magnetic field strength that can be provided. One possible solution to these problems is to attach rigid magnetizable elements to a layer of flexible material in order to provide a desired magnetic field strength while still allowing at least some flexibility, where each rigid magnetizable element is a solid piece of magnetizable material instead of a non-magnetizable material in which solid magnetizable particles are embedded. As such, each piece of solid magnetizable material is fully magnetizable. An example of a solid magnetizable material that can be used in accordance with the invention is a piece of neodymium iron boron (NIB) magnetizable material.

C 100. Semi-flexible magnetic structure 100 can include a flexible layer 102. Flexible layer 102 can be constructed of any desired flexible material, for example, rubber, plastic, fabric, or any other flexible material as desired. In addition to being flexibly deformable, flexible layer 102 can also be elastically deformable.

Semi-flexible magnetic structure 100 can also include an array of magnetizable elements 104, which can be adhered, attached, or otherwise disposed on flexible layer 102. Magnetizable elements 104 can be constructed of any desired magnetizable material. Magnetizable elements 104 can be any shape or size as desired, and can be arranged on flexible layer 100 in any desired pattern or configuration. Once magnetizable elements 104 are added to layer 102, they can be magnetized as discussed in U.S. Pat. No. 8,179,219 filed 2 Jun. 2009, titled “Field Emission System and Method,” which is hereby incorporated herein. For simplicity, the drawings provided herein depict only one magnetic source per magnetizable element but as described in U.S. Pat. No. 8,179,219, a piece of magnetizable material (or magnetizable element) can have multiple magnetic sources magnetized at different locations on the magnetizable material in any desired polarity pattern including adjacent magnetic sources that have the same polarity or opposite polarity. Generally, one skilled in the art of magnetizing will recognize that a semi-flexible magnetic structure can be magnetized as if it were one piece of magnetizable material, where a given magnetizing field may magnetize a magnetic source into only one magnetizable element or may magnetize across two or more magnetizable elements depending on the size of the aperture of the magnetizer's inductor coil, the size of the magnetizable elements, and the magnetizing field strength.

In this way, semi-flexible magnetic structure 100 can be a grid of solid magnetic material which can be magnetized in any desired pattern and which can be supported by a flexible material in such a way that semi-flexible magnetic structure 100 is at least partially flexibly deformable.

The bend modulus or diameter around which semi-flexible magnetic structure 100 can be bent can be affected by the size, shape, and spacing of magnetizable elements 104. Increasing the spacing between magnetizable elements 104 or decreasing the size of magnetizable elements 104 can decrease the diameter which semi-flexible magnetic structure 100 is capable of accommodating. FIG. 2A shows a side view of semi-flexible magnetic structure 100 with magnetizable elements 104 of a certain size arranged with a certain spacing. FIG. 2B shows a side view of semi-flexible magnetic structure 100 in which the size of magnetizable elements 104 has been decreased. FIG. 2C shows a side view of semi-flexible magnetic structure 100 in which the spacing between of magnetizable elements 104 has been increased.

In some embodiments, semi-flexible magnetic structure 100, flexible layer 102, and magnetizable elements 104 can be any size, shape or configuration as desired. As an example, FIG. 3 shows an embodiment of semi-flexible magnetic structure 100 in which magnetizable elements 104 are constructed in a circular shape. As another example, FIG. 4 shows an embodiment of semi-flexible magnetic structure 100 in which magnetizable elements 104 are constructed in a triangular shape.

The exemplary semi-flexible magnetic structures thus shown have been made up of rows and columns of magnetizable elements. However, semi-flexible magnetic structures can be produced of magnetizable elements having other orientations where the spacing between elements can be uniform or non-uniform or any desired combination to include random. As yet another example, FIG. 5 shows an embodiment of semi-flexible magnetic structure 100 in which flexible layer 102 is configured as a circle, and magnetizable elements 104 are constructed in a hexagonal shape. The elements 104 are shown oriented in concentric circles where the spacing between elements varies with different circles.

In other embodiments, semi-flexible magnetic structure 100, flexible layer 102, and magnetizable elements 104 can be configured in any other shape or size as desired, where elements 104 can have the same shape but vary in size, have the same size but vary in shape, or any other desired combination. One skilled in the art will recognize that a given semi-flexible magnetic structure can have different portions that are designed such that one portion has a different bend modulus from another portion and that different portions can be magnetized to have different magnetic properties including field strengths, different tensile forces, different shear forces, and the like. Moreover, coded polarity patterns can be implemented so that semi-flexible magnetic structures can correlate with each other, etc. Generally, coded polarity patterns that can be applied to rigid magnetic materials can be applied to semi-flexible magnetic structures as taught herein and also to prior art flexible materials.

While particular embodiments of the invention have been described, it will be understood, however, that the invention is not limited thereto, since modifications may be made by those skilled in the art, particularly in light of the foregoing teachings.

1. A semi-flexible magnetic structure, comprising:
a flexible layer, and
a plurality of magnetizable elements adhered to said flexible layer such that there is a spacing between magnetizable elements of said plurality of magnetizable elements that enables said semi-flexible magnetic structure to bend around an object, said semi-flexible magnetic structure being magnetized to have a plurality of magnetic sources in a polarity pattern, wherein each magnetizable element of said plurality of magnetizable elements is a solid piece of magnetizable material.

2. The semi-flexible magnetic structure of claim 1, wherein each magnetic source of said plurality of magnetic sources is magnetized by positioning an aperture of an inductor coil of a magnetizer at a location adjacent to a surface of said semi-flexible magnetic structure and exposing said location to a magnetizing field produced in and near said aperture.

3. The semi-flexible magnetic structure of claim 2, wherein each magnetic source of said plurality of magnetic sources has one of a first polarity or a second polarity exposed at said surface of said semi-flexible magnetic structure and an opposite polarity of said first polarity or said second polarity not exposed at said surface of said semi-flexible magnetic structure.

4. The semi-flexible magnetic structure of claim 3, wherein said flexible layer comprises one of rubber, plastic, or fabric.

5. The semi-flexible magnetic structure of claim 1, wherein said flexible layer is flexibly deformable.

6. The semi-flexible magnetic structure of claim 1, wherein said flexible layer is elastically deformable.

7. The semi-flexible magnetic structure of claim 1, wherein at least one of said magnetizable elements of said plurality of magnetizable elements is round.

8. The semi-flexible magnetic structure of claim 1, wherein at least one of said magnetizable elements of said plurality of magnetizable elements is square shaped.

9. The semi-flexible magnetic structure of claim 1, wherein at least one of said magnetizable elements of said plurality of magnetizable elements is hexagonal shaped.

10. The semi-flexible magnetic structure of claim 1, wherein at least one of said magnetizable elements of said plurality of magnetizable elements is triangle shaped.

11. The semi-flexible magnetic structure of claim 1, wherein said plurality of magnetizable elements is configured as a grid.

12. The semi-flexible magnetic structure of claim 11, wherein said grid comprises rows and columns.

13. The semi-flexible magnetic structure of claim 1, wherein said spacing between magnetizable elements is a uniform spacing.

14. The semi-flexible magnetic structure of claim 1, wherein said spacing between magnetizable elements is a non-uniform spacing.

15. The semi-flexible magnetic structure of claim 1, wherein said magnetizable elements of said plurality of magnetizable elements have the same shape but different sizes.

16. The semi-flexible magnetic structure of claim 1, wherein said magnetizable elements of said plurality of magnetizable elements have the same size but different shapes.

17. The semi-flexible magnetic structure of claim 1, wherein different portions of said semi-flexible magnetic structure are designed such that one portion has a different bend modulus from another portion.

18. The semi-flexible magnetic structure of claim 1, wherein said semi-flexible magnetic structure is magnetized to have substantially uniform magnetic properties.

19. The semi-flexible magnetic structure of claim 1, wherein different portions of said semi-flexible magnetic structure are magnetized to have different magnetic properties, wherein said magnetic properties comprises one of magnetic field strength properties, tensile force properties, or shear force properties.

20. The semi-flexible magnetic structure of claim 1, wherein said semi-flexible magnetic structure is magnetized in accordance with a coded polarity pattern enabling said semi-flexible magnetic structure to correlate with a second semi-flexible magnetic structure also magnetized in accordance with said coded polarity pattern.
